(19) United States
(12) Patent Application Publication
(10) Pub. No.: US 2010/0258019 A1
(43) Pub. Date: Oct. 14, 2010

(54) METHOD OF TRANSFERRING PATTERN

(75) Inventor: Mu-Te Chien, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 12/756,197

(22) Filed: Apr. 8, 2010

Related U.S. Application Data
(60) Provisional application No. 61/168,225, filed on Apr. 10, 2009.

(51) Int. Cl. B41F 16/00; B41F 17/00

(52) U.S. Cl. 101/487

(57) ABSTRACT

The invention is a method for transferring patterns on a key module. The key module includes a base and a plurality of keys assembled to the base, and a space exists between each of the keys and the base. The method includes following steps. A support jig is assembled to the key module. The support jig has a plurality of support portions filling the space to fix positions of the keys relative to the base. A film is positioned on the keys. A plurality of patterns respectively corresponding to the keys are disposed on the film. The film is heated and pressed, such that the patterns are transferred to the keys.

### CROSS-REFERENCE TO RELATED APPLICATION

This application claims the priority benefit of U.S.A. provisional application Ser. No. 61/168,225, filed on Apr. 10, 2009. The entirety of the above-mentioned patent application is hereby incorporated by reference herein and made a part of specification.

### BACKGROUND OF INVENTION

1. Field of Invention

The invention relates to a method of transferring patterns. More particularly, the invention relates to a method of transferring patterns onto keys.

2. Description of Related Art

Currently, image transfer technologies are often applied for decorating and labeling products. To satisfy requirements for product decoration and product labeling, so far various image transfer technologies have been developed and employed. Among the image transfer technologies, thermal transfer technology is extensively applied for embellishing the products.

A keyboard on a notebook computer is taken for example. In a conventional transfer technology, a set of keys is assembled to a jig, and a film having a plurality of patterns is disposed on and fixed to the keys. The film is pressed and heated to transfer the patterns on the film to surfaces of the keys. The keys disassembled from the jig are assembled to a base of the keyboard according to their corresponding positions. However, the keys are likely to be misarranged on the base when the conventional transfer technology is adopted.

### SUMMARY OF INVENTION

The invention is directed to a method for transferring patterns. By applying said method, a key module can have a favorable assembly yield.

In an embodiment of the invention is a method for transferring patterns on a key module. The key module includes a base and a plurality of keys assembled to the base, and a first space exists between each of the keys and the base. The method includes following steps. A support jig is assembled to the key module. The support jig has a plurality of first support portions filling the first spaces to fix positions of the keys relative to the base. A film is positioned on the keys. A plurality of patterns respectively corresponding to the keys are disposed on the film. The film is heated and pressed, such that the patterns are respectively transferred to the keys.

As described in the above embodiments of the invention, by assembling the support jig to the key module, the keys can be fixed to the base according to their corresponding positions. Further, when the film is pressed and heated, the patterns can be smoothly transferred to the keys. Thereby, the key module can directly proceed with assembly and then pattern transfer, so as to effectively simplify the assembly process of the key module and improve assembly yield of the key module.

It is to be understood that both the foregoing general descriptions and the detailed embodiments are exemplary and are, together with the accompanying drawings, intended to provide further explanation of technical features and advantages of the invention.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 to FIG. 5 are cross-sectional views illustrating a method for transferring patterns according to an embodiment of the invention.

### DESCRIPTION OF EMBODIMENTS

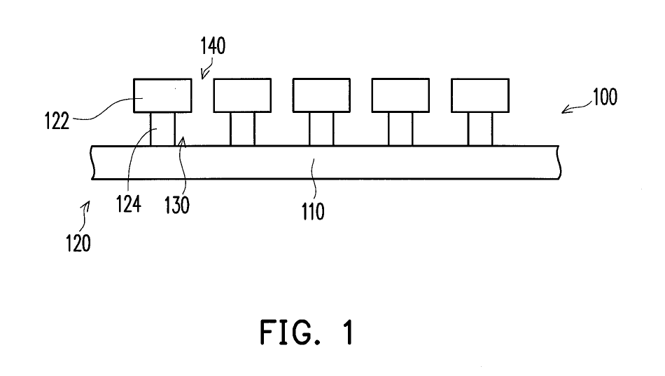

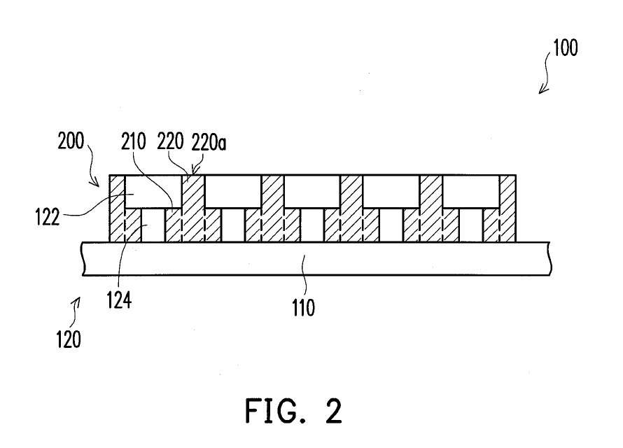

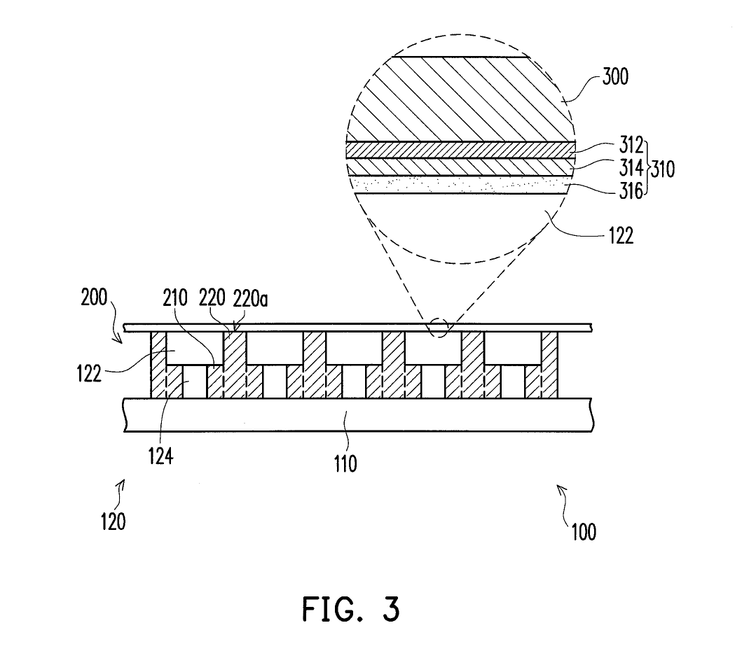

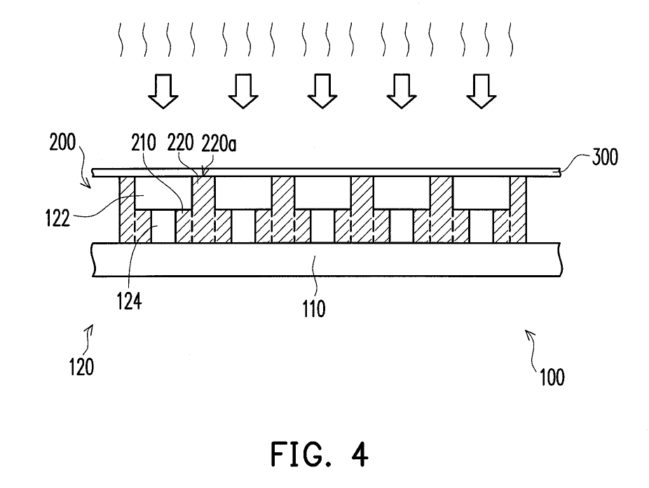

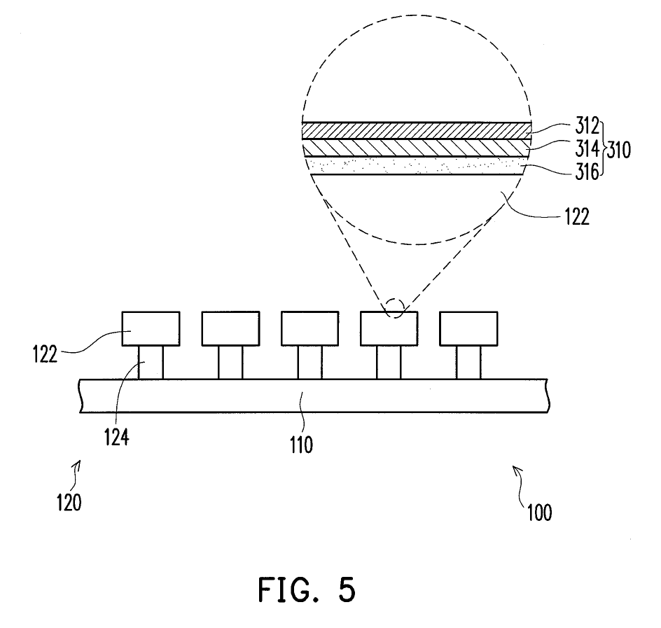

In order to elaborate a process of transferring patterns to keys, please refer to FIG. 1 to FIG. 5 which are cross-sectional views illustrating a method for transferring patterns according to an embodiment of the invention. In FIG. 1, according to this embodiment, the invention is the method for transferring patterns on a key module 100. The key module 100 is, for example, a keyboard on a notebook computer, which should not be construed as limited to the embodiment set forth herein. The key module 100 includes a base 110 and a plurality of keys 120 assembled to the base 110, and a first space 130 exists between each of the keys 120 and the base 110. In FIG. 2, a support jig 200 is assembled to the key module 100. The support jig 200 has a plurality of first support portions 210 filling the first spaces 130 to fix positions of the keys 120 relative to the base 110. In FIG. 3, a film 300 is positioned on the keys 120. A plurality of patterns 310 respectively corresponding to the keys 120 are disposed on the film 300. In FIG. 4, the film 300 is heated and pressed, such that the patterns 310 are respectively transferred to the keys 120.

Based on the above embodiment of the invention, the support jig 200 assembled to the key module 100 has the first support portions 210 filling the first spaces 130 between the keys 120 and the base 110, such that the keys 120 can be supported by the first support portions 210 of the support jig 200, and that a constant distance can be maintained between the keys 120 and the base 110. When the film 300 is pressed for pattern transfer, positions of the keys 120 relative to the base 110 can be fixed by the support jig 200. Thereby, when the film 300 is pressed, flatness of the film 300 can be guaranteed. Besides, the patterns 310 can be smoothly transferred to the keys 120.

Detailed descriptions are further provided hereinafter. In FIG. 1 and FIG. 2, each of the keys 120 in the key module 100 of this embodiment includes a keycap 122 and an elastic element 124 connected between the keycap 122 and the base 110, such that the keycap 122 returns, to an initial position relative to the base 110. The first space 130 exists between each of the keycaps 122 and the base 110. The keycaps 122 can move relative to the base 110 in a back-and-forth manner via the elastic element 124. Hence, when the support jig 200 is assembled to the key module 100, the first support portions 210 of the support jig 200 fill the first spaces 130, such that the keycaps 122 stay at the initial position. As indicated in FIG. 4, when the film 300 is pressed, surfaces of all of the keycaps 122 are on the same plane.

Additionally, a second space 140 exists between every two adjacent keycaps 122, and the support jig 200 has a plurality of second support portions 220 connected to the first support portions 210. When the support jig 200 is assembled to the key module 100, the second support portions 220 fill the second spaces 140 to fix relative positions of the adjacent keycaps 122. As such, relative displacement does not take place between the adjacent keycaps 122. It should be further mentioned that each of the second support portions 220 has a support surface 220a, and each of the support surfaces 220a and a surface of each of the keycaps 122 adjacent to the corresponding support surface 220a are substantially located on the same plane when the second support portions 220 fill the second spaces 140.

As such, the relative positions of the keycaps 122 and the positions of the keycaps 122 relative to the base 110 can be simultaneously fixed by the first support portions 210 and the second support portions 220 of the support jig 200. That is to say, after the first spaces 130 and the second spaces 140 are filled with the support jig 200, the keys 120 can be supported. Thereby, when the film 300 shown in FIG. 4 is subsequently pressed, each of the support surfaces 220a of the second support portions 220 and a surface of each of the keycaps 122 are substantially located on the same plane. As indicated in FIG. 3 and FIG. 4, no matter the film 300 is pressed by a roller or by a punch during the process of transferring the patterns 310, the film 300 can be supported by the keycaps 122 of the keys 120 and the second support portions 220 of the support jig 200 while the flatness of the film 300 is guaranteed. In addition, since pressure is evenly applied to the keys 120, the patterns 310 on the film 300 can be smoothly transferred to the keys 120.

Moreover, in this embodiment, the support jig 200 has a stripe shape. After the keys 120 are assembled to the base 110, the stripe-shaped support jig 200 fills the first and the second spaces 130 and 140 from a side of the key module 100. Upon completion of transferring the patterns 310, the support jig 200 is removed from the side of the key module 100. Note that the external configuration of the support jig 200 and how the support jig 200 is assembled to the key module 100 are not limited in this embodiment. Namely, this embodiment is applicable as long as the relative positions of the keys 120 and the positions of the keys 120 relative to the base 110 are fixed.

On the other hand, as indicated in FIG. 3 to FIG. 5, the film 300 of this embodiment is a release layer. However, the film 300 can also be formed by coating a release layer on base materials, such as polymer, metal, or paper. Each of the patterns 310 on the film 300 includes a passivation layer 312, an ink layer 314, and an adhesive layer 316. The passivation layer 312 is disposed on the film 300, the ink layer 314 is disposed on the passivation layer 312, and the adhesive layer 316 is disposed on the ink layer 314. When the process indicated in FIG. 4 is performed, the film 300 is heated and pressed by a transfer jig (not shown). Here, the passivation layer 312 and the ink layer 314 are adhered to the keycaps 122 via the adhesive layer 316. By a release effect of the film 300, the passivation layer 312 and the ink layer 314 are detached from the film 300, such that the patterns 310 are transferred to the keys 120. In this embodiment, the adhesive layer 316 can be disposed merely on the ink layer 314. Namely, it is not necessary to form the adhesive layer 316 on the entire film 300, so as to economize the use of materials of the adhesive layer 316. Further, the film 300 can be lifted off more smoothly in a subsequent step, and quality of the transferred patterns 310 on the keys 120 can be improved.

In light of the foregoing, by, assembling the support jig to the key module, the positions of the keys relative to the base can be fixed, and simultaneously the surface of each of the keys and the support surfaces of the support jig are on the same plane. When the film is pressed and heated, the film can be placed on the keys while the flatness of the film is guaranteed. Thereby, the patterns can be smoothly and unerringly transferred to the keys. As such, the key module can be assembled to the base, and then the pattern transfer process is performed, so as to prevent incorrect arrangement of the keys which usually occurs when the conventional transfer technology is adopted. In other words, by means of the support jig, the assembly process of the key module can be effectively simplified, and assembly yield can be improved as well.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for transferring patterns on a key module, the key module comprising a base and a plurality of keys assembled to the base, a first space existing between each of the keys and the base, the method comprising:
assembling a support jig to the key module, wherein the support jig has a plurality of first support portions filling the first spaces to fix positions of the keys relative to the base;
positioning a film on the keys, wherein the patterns respectively corresponding to the keys are disposed on the film; and
heating and pressing the film, such that the patterns are transferred to the keys.

2. The method as claimed in claim 1, wherein a second space exists between every two of the keys adjacent to each other, and the support jig has a plurality of second support portions filling the second spaces to fix relative positions of the adjacent keys.

3. The method as claimed in claim 2, wherein each of the second support portions has a support surface, and each of the support surfaces and a surface of each of the keys adjacent to the each of the support surfaces are substantially located on a same plane.

4. The method as claimed in claim 1, each of the keys comprising:
a keycap; and
an elastic element connected between the keycap and the base, such that the keycap returns to an initial position relative to the base,
wherein the first space exists between the keycap and the base.

5. The method as claimed in claim 4, wherein a second space exists between every two of the keycaps adjacent to each other, and the support jig has a plurality of second support portions filling the second spaces to fix relative positions of the adjacent keycaps.

6. The method as claimed in claim 5, wherein each of the second support portions has a support surface, and each of the support surfaces and a surface of each of the keycaps adjacent to the each of the support surfaces are substantially located on a same plane.

7. The method as claimed in claim 1, wherein a step of pressing the film comprises rolling or punching.

8. The method as claimed in claim 1, each of the patterns comprising:
a passivation layer disposed on the film;
an ink layer disposed on the passivation layer; and
an adhesive layer disposed on the ink layer.

9. The method as claimed in claim 1, wherein the film is a release layer.
